(19) United States
(12) Patent Application Publication
(10) Pub. No.: US 2012/0074098 A1
(43) Pub. Date: Mar. 29, 2012

(54) Process for Treatment of the Surface of a Dental Implant

(76) Inventors: Hugo NARY FILHO, Bauru-SP (BR); Hiron Andreaza Da Cunha, Goiania-GO (BR)

(21) Appl. No.: 12/915,876

(22) Filed: Oct. 29, 2010

(30) Foreign Application Priority Data
Sep. 24, 2010 (BR) 018100035800

(51) Int. Cl. A61C 13/00; C23F 1/00

(52) U.S. Cl. 216/53

(57) ABSTRACT

A processes for treating the surface of a dental implant wherein the dental implant after the machining operation undergoes a sequence of processes that are associated with the removal of all surface contamination, promoting the conditions to form a texturing and an oxide layer with thickness and composition that induces the interaction between the organism and the implant.

### FIELD OF THE INVENTION

The present invention is in the field of processes for treating dental implants.

### BACKGROUND OF THE INVENTION

Dental implants are structures used in dental treatments that form an artificial tooth structure in the region of tooth loss for fixing a dental prosthesis.

Dental implants are manufactured in biocompatible materials, for instance, titanium, which when being machined are operationally molded in formats compatible for the implantation in the body. However, after the production of each unit, the implant passes through the cleaning and sterilization.

The success of dental implants are directly associated with the quality of the implant in both its structural forms, and the material produced at the treatment he receives the surface of this material that is in contact with the organism that can react with infection and rejection of the material.

There are some solutions reported in prior patents of which we include documents PI 0602093-3 (BR) and PI 0802298-4. (BR)

Document PI0602093-3 (BR) 25, May 2006 entitled “ELECTROCHEMICAL METHOD FOR TREATING THE SURFACE OF TITANIUM IMPLANTS AND TITANIUM ALLOYS FOR USE IN DENTISTRY AND MEDICINE”, presents a technical procedure for electrolytic treatment of titanium implants surface used in dentistry and medicine, known by the application of a series of baths, testing, blasting, acid treatment and electrolytic treatment in order to increase the active surface area of the implant and promote greater biocompatibility of titanium treatments implants, the technique developed and used is based on the electrochemical technique and electrolytes.

Further, PI0802298-4 (BR) from 20, Jun. 2008 entitled “PROCESS FOR TREATMENT OF AN IMPLANT AND IMPLANT BASED ON PROTEIN TREATY” is a process for handling an implant comprising a substrate of protein, which comprises the steps wherein: The substrate of protein is treated with a compound carrying at least one aldehyde group, and then the substrate is treated with a compound that comprises a borohydride, and then the substrate from the step is treated with a secondary carrier from a silane group.

The prior art discussed above cites, possible uses in surface treatment of dental implants. However, they do not fully meet the goals leading to rejection by not eliminating all impurities in the solid body of the implant.

Given the existing problems and aiming to offer a quality implant for the interaction between the organism and the implant is that the applicant has developed the present unique process for treatment on the surface of dental implant that after the machining operation goes through a sequence of treatment that are associated with the removal of all surface contamination and promoting the conditions for formation of a texturing and an oxide layer thickness and composition that induces the interaction between the organism and the implant.

### SUMMARY OF THE INVENTION

The present application provides an inventive solution in biocompatible surface treatment in the form of dental implants after a machining operation that involves a sequence of treatments that are associated to remove all surface contamination and promoting the conditions for formation of a texturing and an oxide layer thickness and composition that induces the interaction between the organism and the implant.

The present application provides a processes for treating the surface of a dental implant, having an internal and an external screw, the process comprising the steps of: (1) cleaning the internal screw of the implant; (2) cleaning the external screw of the implant a first time; (3) rinsing the implant a first time;(4) drying the implant; (5) blasting the implant; (6) cleaning the external screw a second time; (7) rinsing the implant a second time; (8) drying the implant a second time; (9) etching the implant a first time; (10) neutralizing the etched implant; (11) rinsing the implant a third time; (12) bathing the implant in isopropyl alcohol; (13) bathing the implant in deionized water; (14) etching the implant a second time; (15) neutralizing the second time etched implant; (16) rinsing the second time etched implant; (17) bathing the second time etched implant in deionized water, and (18) drying the second time etched implant.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

In the process of the present application, the following steps are performed:

(1) Cleaning the Internal Screw:

In this step, there is allocation of the implant in a specific (proper) device that provides the internal cleaning of the screw. The cleaning is done by means of immersion in a first tank where a washing solution based on D'Limonemo, in average heated concentration of 3:50, is pressurized for about 20 to 30 minutes through holes for the internal cleaning of the implant. This will expel the particles housed internally under the manufacturing process; such as oils, greases and other contaminants.

(2) Cleaning the External Screw (2):

After the internal cleaning process of the screw, the implant is placed in another device specific (proper) for external cleaning and immersed for about 20/30 minutes on a second tank. Here it is used ultrasound and the washing solution based on D'Limonemo, in average heated concentration of 3:50, in order to remove particles housed externally.

(3) Rinsing the Implant a First Time:

Completed the processing time for the internal and external cleaning, the dental implant is immersed in a tank filled with deionized water to remove the washing liquid.

(4) Drying the Implant a First Time:

After rinsing, the implant undergoes a drying process and it is accomplished through a dryer with temperature ranging from about 70° to about 80° C. The implant is placed in a (proper) device placed inside the dryer for about 30 to 40 minutes.

(5) Blasting the Implant:

This step is performed in the blasting chamber using abrasive aluminum oxide (Al₂O₃) with an average particle size of 90 microns. The abrasive blasting with aluminum oxide creates a microporous and superficial roughness, i.e. the production of a topography that creates an additional mechanism for anchoring the early stages of the osseointegration.

(6) Second Cleaning of the External Screw

After the blasting, the implants undergo a second external cleaning process of the external screw. They are allocated in a specific (proper) device for external cleaning and immersed for about 20 to 30 minutes in a second tank. Here ultrasound is also used and a washing solution based on D'Limonemo, in average heated concentration of 3:50, to remove particles housed externally.

(7) Second Rinsing of the Implant

Completed the process of cleaning the external screw, the dental implant is immersed in a tank filled with deionized water to remove the washing liquid.

(8) Drying the Implants a Second Time:

After the rinsing, the implant undergoes a second drying process. The drying process is accomplished by means of a dryer with a temperature ranging from about 70° to about 80° C. The implant is placed in a (proper) device placed inside the dryer for about 30 to 40 minutes.

(9) First Etching of the Implant:

The first etching process, or first acid attack, constitutes the chemical surface treatment in which the implant is submitted in order to homogenize the rough surface created earlier. To carry out this step, the implant is placed in a specific (proper) device and immersed in an identified container containing the etching solution (an acid solution consisting of from 10% to 30% in volume of nitric acid 70% and from 1% to 3% in volume of hydrofluoric acid 60% at 50° C.) for a maximum time of 2 minutes.

(10) Neutralizing the Etched Implant:

Following this etching, the neutralization of the implant is performed, so they are removed from the vessel containing the acid solution and immersed into a container with a neutralizing solution of sodium bicarbonate, having a pH of between 6 and 8. Then, the products are dipped into a bowl with 2 of the same solution of sodium bicarbonate, having a pH of between 7 and 8.

(11) Rinsing the Implant a Third Time:

After the neutralization, the implant is immersed in a tank with deionized water only for the cleaning of waste liquids.

(12) Bathing the Implant With Isopropyl Alcohol:

The purpose of the baths (immersion of the implant for a controlled period of time of from 20 to 30 minutes) is to eliminate waste and remnant particles as well as additional cleaning activity with the dissolution of the chemical effects of acid attacks in which dental implants are undergone at the superficial treatment area. The dental implant bath in isopropyl alcohol (C₃H₈O) 99.5%, has spectrum of quick and dispersant action, and acting against organic agents providing the denaturing of the residues of the background processes. The implant is placed in a specific (proper) device and immersed for a period of time of about 20 minutes in a specific (proper) container.

(13) Bathing the Implant in Deionized Water:

Bathing the dental implant in heated Deionized Water (H₂O without ions) promotes purification due to the properties of chemical purity. The implant is placed in a specific (proper) device and immersed for about 20 minutes in a tank with heated deionized water.

(14) Second Etching of the Implant (Passivation):

The process of chemical passivation or second acid attack results in the formation of a transparent protective film of titanium oxide (TiO₂) on the surface of the implant. The protective film ensures the durability of the implant. In this step, the implant is placed in a specific (proper) device and immersed in a tank with passivation solution (solution based on deionized water and nitric acid—HNO₃ at a concentration of 30% in weight) for about 40 minutes.

(15) Neutralizing the Second Time Etched Implant:

Following the second etching, a neutralization of the implant is performed, so they are removed from the passivating solution and immersed in a container with a neutralizing solution of sodium bicarbonate, at a pH from 7 to 8.

(16) Rinising the Second Time Etched Implant:

Ended the neutralization, the implant is immersed in a tank with deionized water, only for cleaning of earlier waste liquids.

(17) Bathing the Second Time Etched Implant in Deionized Water:

In this step the implant is immersed for about 20 minutes in a tank with heated deionized water to complete the process.

(18) Drying the Second Time Etched Implant:

The implant goes through the drying process once again and it is accomplished through a dryer at a temperature ranging from about 70° to about 80° C. The implant is placed in a (proper) device placed inside the dryer for a period of time of ranging from about 30 to 40 minutes.

1. A processes for treating the surface of a dental implant, having an internal and an external screw, the process comprising the steps of:
(1) cleaning the internal screw of the implant;
(2) cleaning the external screw of the implant a first time;
(3) rinsing the implant a first time;
(4) drying the implant a first time;
(5) blasting the implant;
(6) cleaning the external screw a second time;
(7) rinsing the implant a second time;
(8) drying the implant a second time;
(9) etching the implant a first time;
(10) neutralizing the etched implant;
(11) rinsing the implant a third time;
(12) bathing the implant in isopropyl alcohol;
(13) bathing the implant in deionized water;
(14) etching the implant a second time;
(15) neutralizing the second time etched implant;
(16) rinsing the second time etched implant;
(17) bathing the second time etched implant in deionized water, and
(18) drying the second time etched implant.

2. A processes for treating the surface of a dental implant, having an internal and an external screw, the process comprising the steps of:
(1) cleaning the internal screw of the implant, wherein the implant is immersed in a washing solution with D'Limonemo, in average heated concentration of 3:50, pressurized for a period of time of about 20 to 30 minutes;
(2) cleaning the external screw of the implant a first time, wherein the implant is immersed in a washing solution with D'Limonemo, in average heated concentration of 3:50, pressurized for a period of time of about 20 to 30 minutes, together with ultrasound;
(3) rinsing the implant a first time, wherein the dental implant is immersed in deionized water;
(4) drying the implant, wherein the implant is placed in a dryer at a temperature ranging from about 70° to about 80° C., for a period of time of about 30 to 40 minutes;
(5) blasting the implant, wherein the implant is placed in a blasting chamber using abrasive aluminum oxide (Al₂O₃) with an average particle size of 90 microns;
(6) cleaning the external screw a second time, wherein the implant is immersed in a washing solution with D'Limonemo, in average heated concentration of 3:50, pressurized for a period of time of about 20 to 30 minutes, together with ultrasound;
(7) rinsing the implant a second time, wherein the dental implant is immersed in deionized water;
(8) drying the implant a second time, wherein the implant is placed in a dryer at a temperature ranging from about 70° to about 80° C., for a period of time of about 30 to 40 minutes;
(9) etching the implant a first time, wherein the implant is immersed in an etching solution consisting of from 10% to 30% in volume of nitric acid 70%, and from 1% to 3% in volume of hydrofluoric acid 60% at 50° C.; for a maximum time of 2 minutes;
(10) neutralizing the etched implant, wherein the implant is immersed in a container with a neutralizing solution of sodium bicarbonate, having a pH of between 6 and 8, and further immersed in a solution of sodium bicarbonate, having a pH of between 7 and 8;
(11) rinsing the implant a third time, wherein the dental implant is immersed in deionized water.
(12) bathing the implant in isopropyl alcohol and deionized water, wherein the implant is immersed in a solution of isopropyl alcohol 99.5%, for a period of time of from 20 to 30 minutes;
(13) bathing the implant in deionized water, wherein the dental implant is immersed in deionized water;
(14) etching the implant a second time, wherein the implant is immersed in a passivation solution consisting of deionized water and nitric acid at a concentration of 30% in weight, for a period of time of about 40 minutes;
(15) neutralizing the second time etched implant, wherein the implant is immersed in a solution of sodium bicarbonate, having a pH of between 7 and 8;
(16) rinsing the second time etched implant, wherein the dental implant is immersed in deionized water;
(17) bathing the second time etched implant in deionized water, wherein the dental implant is immersed in deionized water;
(18) drying the second time etched implant, wherein the implant is placed in a dryer at a temperature ranging from about 70° to about 80° C., for a period of time of about 30 to 40 minutes.
